(19) United States
(12) Patent Application Publication
(10) Pub. No.: US 2002/0186125 A1
(43) Pub. Date: Dec. 12, 2002

(54) System and method for providing high-speed communications over an electrical network

(76) Inventor: Victor Tzar Kuoi Li, Central HK (CN)

Correspondence Address: Mitchell P. Brook, Baker & McKenzie, Twelfth Floor, 101 Broadway, San Diego, CA, 92101, US

(21) Appl. No.: 09/896,870

(22) Filed: Jun. 28, 2001

Related U.S. Application Data
(60) Provisional application No. 60/296,893, filed on Jun. 8, 2001.

(51) Int. Cl. H04M 11/04

(52) U.S. Cl. 340/310.08

(57) ABSTRACT

A system and a method for providing a high-speed communications network transparently over an existing electrical network of a building are provided. A host unit and one or more subscriber units are each coupled to the electrical network of the building. In particular, the host unit is plugged into a electrical socket of the electrical network of the building. The host unit is coupled to a communications network. The subscriber unit is in communications with communications network via the electrical network.

Priority is claimed from U.S. Provisional Patent Application Serial No. 60/296,893, filed on Jun. 8, 2001, entitled “Apartment-Based High Speed Communication Over Power Cable in Multi-Level Buildings”, which is incorporated herein by reference in its entirety.

### FIELD OF THE INVENTION

The present invention generally relates to a system and method for providing communications over an electrical network and, more specifically, relates to a system and a method for providing high-speed communications over an electrical network.

### BACKGROUND OF THE INVENTION

Conventional implementations of high-speed access via copper, cable or wireless networks in, for example, multi-level buildings may suffer from a number of difficulties in the deployment stage. For example, to install a local cable network throughout a multi-level building and, in particular, to reach each apartment, cables may be physically deployed throughout the building and holes would have to be drilled in some walls in each apartment so that each apartment could access the local cable network. In addition, existing constraints such as, for example, limited conduit space and clogged horizontal conduits may provide additional challenges. Overcoming such difficulties with a separate cabling installation has proven to be labor intensive, costly and intrusive.

Thus, there is a need for a method and a system that enables fast and easy delivery of high-speed services (e.g., broadband services) to end users.

### SUMMARY OF THE INVENTION

The present invention alleviates to a great extent the disadvantages of conventional systems and methods for providing high-speed communications.

In an exemplary embodiment, the present invention provides a host unit and one or more subscriber units that are installed inside building units of a building. The host unit and the subscriber units are each coupled to the electrical network or electrical network of the building. In particular, the host unit is plugged into a electrical socket of the electrical network. The host unit is also coupled to a communications network such as, for example, a telecommunications backbone network via an interface such as, for example, an optical fiber interface or a copper wire/cable interface. The host unit provides aggregation of internet or other types of network traffic within the building and provides access to the telecommunications backbone network for each of the subscriber units. High-speed communications signals that facilitate various network service are distributed within the building via the electrical lines inside the building.

The present invention has an advantage of using an existing electrical distribution network of the building to provide a high-speed communications network. Advantageously, the present invention may also use an existing electrical network connection such as an existing electrical socket as a high-speed communications network interface.

In addition, the present invention provides transparency in deploying the high-speed communications network over the existing electrical network of the building. The host unit and the subscriber units may be coupled via, for example, regular electrical sockets that may already be available in each building unit of the building. Transparency is further enhanced by the host unit and the subscriber unit not being connected to the electrical distribution facilities outside the units of the buildings.

The present invention also has an advantage in reducing the need to deploy high-speed communications equipment in public areas of the building such as, for example, meter rooms. Consequently, the present invention also reduces the need to apply for regulatory and/or building management approval.

The present invention also has advantage in that the existing electrical network may be adapted to provide an arrangement for use in an intra-building network such as, for example, a local area network or an internet community.

These and other features and advantages of the present invention will be appreciated from review of the following detailed description of the present invention, along with the accompanying figures in which like reference numerals refer to like parts throughout.

### BRIEF DESCRIPTION OF THE DRAWINGS

FIG. 1 is a schematic representation of a building with an electrical line network in which a host unit is installed in a meter room;

FIG. 2 is a schematic representation of a host unit installed inside a meter room;

FIG. 3 is a schematic representation of a host unit coupled to an electrical network of a building according to the present invention; and

FIG. 4 is a schematic representation of a plurality of host units coupled to an electrical network of a building according to the present invention.

### DETAILED DESCRIPTION OF THE INVENTION

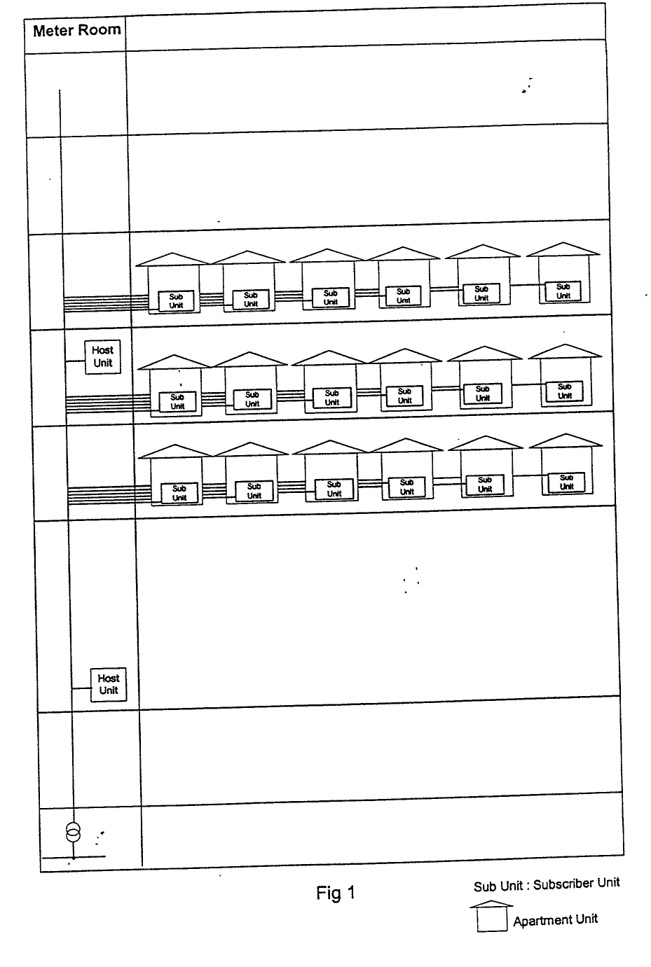

FIG. 1 illustrates that a multi-level building 110 may include a plurality of levels or floors 120 and an existing electrical network 130 that extends to each building unit 140.

Each floor 120 may include at least one building unit 140 (e.g., an apartment, an office, a room, etc.). Each floor 120 is illustrated as having a meter room 150 (although each floor 120 need not include a meter room 150). Each of the building units 140 is typically already coupled to the electrical network 130. One or more host units 160, which are illustrated as being disposed in particular meter rooms 160, are each coupled to the electrical network 130. Although two host units 160 are illustrated, more or less than two host units 160 may be provided. A subscriber unit 170 may be disposed in a building unit 140 and may be coupled to the electrical network 130. A plurality of subscriber units 170 are illustrated as being disposed in a plurality of building units 140 on some floors 120. The subscriber units 170 and the host units 160 are in communications via the electrical network 130.

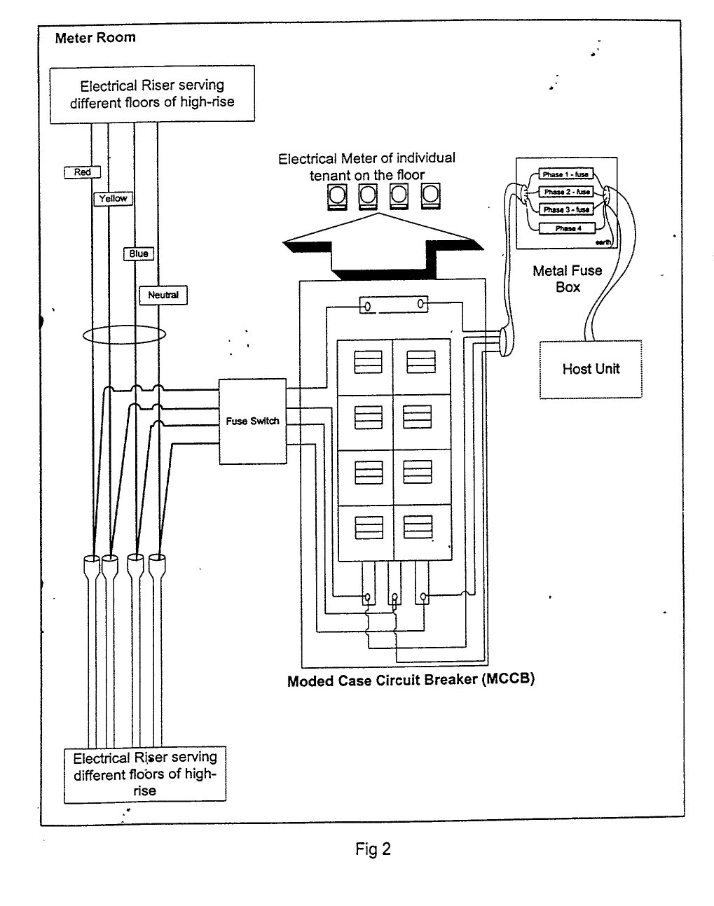

FIG. 2 illustrates that the meter room 150 may include, for example, a fuse switch 180, a circuit breaker panel 190, a fuse box 200, one or more meters 210 (e.g., watt-hour meters) and a portion of an electrical riser 220. The host unit 160 may be coupled to any device or system through which power or electricity is distributed to the building units 140 on one or more floors 120. For example, the host unit 160 is coupled to the fuses 205 of the fuse box 200 which, in turn, are coupled to bus bars 215 of the circuit breaker panel 190. The bus bars 215 of the circuit breaker panel 190 are coupled to the fuse switch 180. The fuse switch 180 is coupled to the electrical riser 220. The electrical riser 220, which may include, for example, four electrical lines (e.g., three-phase electrical lines and a neutral line), may extend through each floor 120. Although not shown, the electrical riser 220 may be coupled to, for example, bus bars of a main switch which, in turn, is coupled to a local power substation via a step-down transformer as known to one of ordinary skill in the art.

The building units 140 on a particular floor 120 may be coupled to the electrical lines of the electrical riser 220 via the circuit breaker panel 190. The meters 210 measure and display the amount of power used in each building unit 140. When a particular subscriber unit 170 of a particular building unit 140 is coupled to the electrical lines of the electrical riser 220, then the particular subscriber unit 170 and the host unit 160 may be in communications with each other.

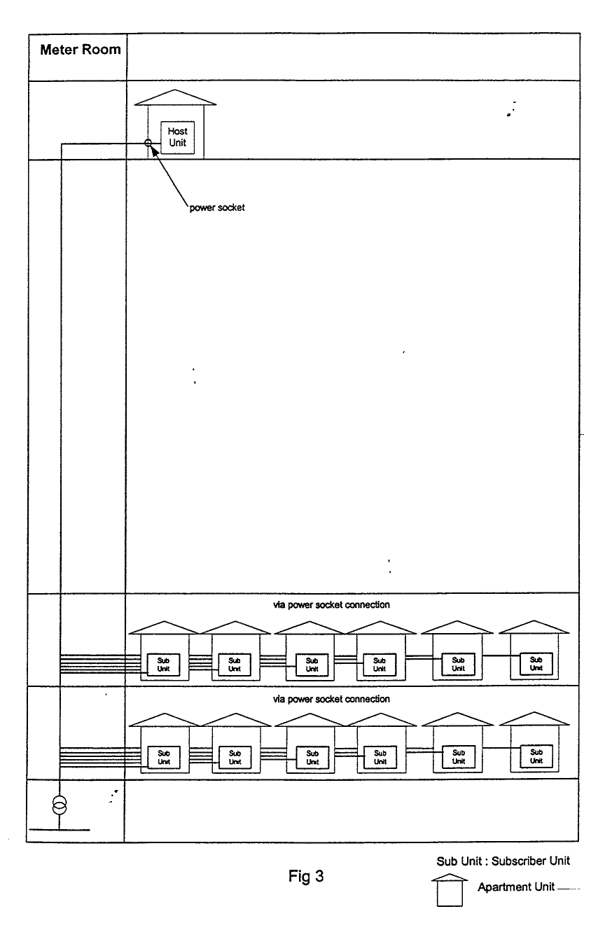

FIG. 3 shows another exemplary embodiment of the high-speed communications network according to the present invention. In this exemplary embodiment, the host unit 160 is not disposed in the meter room 150. Instead, one or more host units 160 may be disposed in one or more building units 140 and coupled to the electrical network 130 via a respective electrical socket 230. For example, the host unit 160 may be directly plugged into the electrical socket 230. The subscriber units 170 may also be coupled to the electrical network 130 via, for example, the electrical sockets 230 in the building units 140. The subscriber units 170 may be disposed, for example, in different building units 140 from the building units 140 in which are disposed the host units 170. However, a subscriber unit 170 and a host unit 160 may be disposed in the same building unit 140. The electrical socket 230 may be, for example, an existing electrical socket or a conventional electrical socket. Thus, the host unit 160 is in communications with the subscriber units 170 (e.g., the subscriber units 170 within the coverage space of a particular host unit 160) via the electrical sockets 230 which provides electrical and communications interfaces to the electrical network 130 of the building 110. The electrical network 130 acts as a building communications network. For example, where the host unit 160 is coupled to an external telecommunications network (e.g., the internet), the host unit 160 may connect the subscriber units 170 to the external telecommunications network over the electrical network 130 (e.g., a low voltage, AC electrical distribution network) to which the host unit 160 and the subscriber units 170 are both connected.

Depending on the particular application, the host unit 160 or the subscriber unit 170 may be structured in a number of configurations. The host unit 160 or the subscriber unit 170 may also include other standard interfaces such as, for example, a single-mode fiber/cable interface, a multimode fiber/cable interface, a universal serial bus (USB) interface, a IEEE 802.3 or ISO 8802-3 ethernet interface (e.g., 10BaseT, 100BaseT, 10BaseFL or 100BaseFX ethernet interface) or other interfaces known to those of ordinary skill in the art. The host unit 160 or the subscriber unit 170 may be configured to support communications, networking or internet protocols such as, for example, dynamic host configuration protocol (DHCP), simple network management protocol (SNMP), terminal emulation protocol (telnet), transmission control protocol/internet protocol (TCP/IP) or any other protocols known to those of ordinary skill in the art.

The host unit 160 or the subscriber unit 170 may include, for example, a radio frequency transmitter, a radio frequency receiver, a local oscillator, a radio frequency modulator, a radio frequency demodulator or other communications components known to those of ordinary skill in the art. Thus, for example, the host unit 160 or the subscriber unit 170 may be adapted to modulate or to demodulate signals transmitted or received on carrier frequencies, for example, between approximately 1 MHz and approximately 30 MHz. Furthermore, the host unit 160 or the subscriber unit 170 may be structured to couple and to decouple modulated and demodulated signals to and from its standard interface.

The host unit 160 or the subscriber unit 170 may include onboard memory storage devices that store embedded applications and subscriber unit addresses that facilitate connection establishment. The host unit 160 or the subscriber unit 170 may also include processors that store and execute embedded applications and systems. Such applications and systems may provide a variety of functions and capabilities such as, for example, data transmission; data buffering; binary operations; synchronizing; handshaking; dynamic bandwidth allocation and control; encrypting; securing access to the operating environment; or analyzing or reporting, for example, frequency response, signal-to-noise ratios or error rates. The embedded systems (e.g., communications components) and applications may provide connection and control via the logical link control (LLC) and the media access control (MAC) according to IEEE or ISO standards such as, for example, IEEE 802.2 LLC, IEEE 802.3 MAC, IEEE 802.1q VLAN or any other applicable IEEE standards known to one of ordinary skill in the art.

Thus, for example, the host unit 160 may be a digital modulation device with a three-phase-plus-neutral electrical interface that connects via, for example, an electrical socket, to a low voltage, AC electrical line distribution network. The host unit 160 may also be a digital modulation device with a single-phase-plus-neutral electrical interface. The switching between a three-phase and a single-phase electrical interface can be implemented using techniques known to those of ordinary skill in the art. The subscriber unit 170 may be a digital modulation device with a single-phase-plus-neutral electrical interface or a three-phase-plus-neutral electrical interface that connects via, for example, an electrical socket, to the low-voltage AC electrical line distribution network on a first end; and, on a second end, an ethernet or USB interface for connecting, for example, a computer of the subscriber to the internet or other types of networks. Added transparency may be achieved if the transmission of signals coming from and to host units and subscriber units are not connected to the power distribution facilities outside the apartments of the building.

The host unit 160 may provide, for example, both the main access to the high-speed communications network as well as a services access point to other subscriber units 170 within the building 110. For example, the host unit 160 may be connected via a single-phase socket interface or a three-phase socket interface to a low voltage, AC electrical socket inside any building unit (e.g., residential apartment) for distribution and collection of signals to and from the subscriber units 170 located inside the same building. Thus, a first subscriber unit 170 may communicate with a second subscriber unit 170 with the host unit 160 passing or handling communications signals carried by the electrical network 130. Furthermore, since the host unit 160 is also coupled to the communications network, a particular subscriber unit 170 may access the communications network such as, for example, the internet.

The host unit 160 may be connected to a high-speed network through a variety of connection means including, for example, copper cables/wires, optical fiber cables or wireless communications means (e.g., via infrared communications, radio-frequency communications, microwave communications, other forms of electromagnetic radiation communications or any other forms of wireless communications known to those of ordinary skill in the art). For example, the ethernet in use with the host unit 160 may be in compliance with networking standards that are known in the art including, for example, IEEE 802.3 or ISO 8802-3. The host unit 160 may also be plugged into any electrical socket in any building unit 140. The subscriber units 170 may also be plugged into electrical sockets 230 of the building units 140 in which the subscriber units 170 are disposed. The one or more subscriber units 170 may thus be in communications to each other and to the high-speed network via the host unit 160.

Further transparency may be achieved since the host unit 160 need not be wired in a building facility unit such as, for example, the meter rooms 150 on the various levels of the building 110. This exemplary arrangement presents an elegant solution which reduces the need for special wiring for high-speed communications access to each building unit 140 in the building 110 and reduces the need to deploy communications equipment in public areas. Furthermore, the present invention may provide for the establishment of a local internet or networking community.

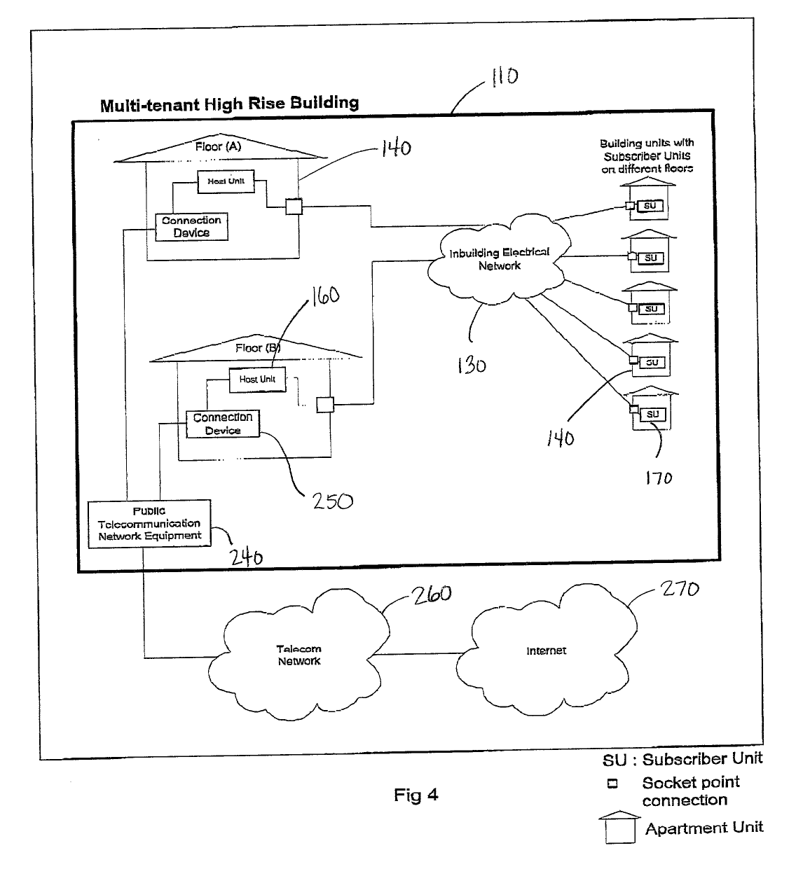

FIG. 4 illustrates another exemplary embodiment in which a plurality of host units 160 are coupled to the electrical network 130 and to the public telecommunications network equipment 240. The host units 160 (which may number more than two) may be coupled to the subscriber units 170 (which may number more than four) via the electrical network 130 including, for example, the electrical sockets of the building 110 (e.g., a multi-level apartment building). The host units 160 may each be coupled to the public telecommunications network equipment 240 via a respective connection device 250 (e.g., an ADSL modem or VDSL modem). The respective connection devices 250 may each be coupled to the public telecommunications network equipment 240 or may each be coupled to a connection point which, in turn, is coupled to the public telecommunications network equipment 240. The public telecommunications network equipment 240 may be coupled to the telecommunications network 260 which, in turn, may be coupled to the internet 270. Alternatively, the connection device 250 may be coupled more directly to the internet 270.

Although the exemplary embodiment appears particularly suited for high-speed communications connection in multi-level buildings, the present invention need not be so limited in scope. The host unit 160 and the subscriber units 170 may be disposed in different buildings of a group of buildings (e.g., a group of buildings on a campus) in which the group of buildings is connected to the same electrical distribution network. Accordingly, the host unit 160 and the subscriber units 170 may be connected into a high-speed communications network via, for example, their respective electrical sockets 230 and the electrical distribution network for the group of buildings.

Thus, it is seen that a system and method for providing high-speed communications are provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the present invention as well.

What is claimed is:

1. A system for providing communications network access via an electrical network of a building, comprising:
a host unit disposed inside the building and having a first interface and a second interface, the first interface being coupled to the communications network, the second interface being coupled to a electrical socket of the building, the electrical socket being coupled to the electrical network of the building; and
a subscriber unit disposed inside the building and having a first interface that is coupled to the electrical network,
wherein the subscriber unit is in communications with the communications network via the electrical network.

2. The system according to claim 1, wherein the communications network is an internet or a telecommunications network.

3. The system according to claim 1, wherein the second interface of the host unit includes a single-phase-plus-neutral electrical interface.

4. The system according to claim 1, wherein the second interface of the host unit includes a three-phase-plus-neutral electrical interface.

5. The system according to claim 1, wherein the second interface of the host unit is plugged into the electrical socket.

6. The system according to claim 1, wherein the first interface of the host unit includes at least one of a multimode fiber interface, a single-mode fiber interface, a universal serial bus (USB) interface and an ethernet interface.

7. The system according to claim 6, wherein the ethernet interface includes at least one of IEEE 802.3 interface, 10BaseT interface, 100BaseT interface, 10BaseFL interface and a 100BaseFX interface.

8. The system according to claim 1, wherein the first interface of the subscriber unit is plugged into a second electrical socket of the building.

9. The system according to claim 1, wherein the subscriber unit is in communications with the communications network via the first interface of the subscriber unit, the electrical network and the host unit.

10. The system according to claim 1, further comprising:
a computer coupled to a second interface of the subscriber unit,
wherein the computer is in communications with the communications network via the electrical network of the building.

11. The system according to claim 1,
wherein the subscriber unit includes a first subscriber unit and a second subscriber unit, the first subscriber unit being coupled to the electrical network at a first part of the electrical network, the second subscriber unit being coupled to the electrical network at a second part of the electrical network, and
wherein the first subscriber unit is in communications with the second subscriber unit via the electrical network.

12. The system according to claim 11, wherein the host unit passes data packets between the first subscriber unit and the second subscriber unit.

13. The system according to claim 11,
wherein the first subscriber unit is in communications with the communications network via the electrical network, and
wherein the host unit passes data packets between the communications network and the first subscriber unit.

14. The system according to claim 13, wherein the communications network is an internet or telecommunications network.

15. The system according to claim 1,
wherein the building is a multi-level building, and
wherein the subscriber unit is a plurality of subscriber units disposed through the multi-level building.

16. A system for accessing an internet via an electrical network of a building, comprising:
a host unit disposed in a first building unit of the building, the host unit being plugged into the electrical network via an electrical socket of the first building unit and being coupled to the internet via a high-speed connection; and
a first subscriber unit disposed in a second building unit of the building, the first subscriber unit being coupled to the electrical network via an electrical interface of the second building unit,
wherein the host unit passes packets of information between the first subscriber unit and the internet via the electrical network.

17. The system according to claim 16, wherein the first subscriber unit is plugged into the electrical network via an electrical socket of the second building unit.

18. The system according to claim 16, further comprising:
a second subscriber unit disposed in a third building unit of the building, the second subscriber unit being coupled to the electrical network via an electrical interface of the third building unit,
wherein the host unit passes packets of information between the first subscriber unit and the second subscriber unit via the electrical network.

19. The system according to claim 18,
wherein the building is a multi-floor building, and
wherein the first subscriber unit and the second subscriber unit are on different floors.

20. The system according to claim 1, wherein the host unit includes a plurality of host units.

21. A system for providing communications network access transparently over an electrical network of a building, comprising:
two or more host units disposed inside the building, each host unit having a first interface and a second interface, each first interface being coupled to the communications network, each second interface being coupled to a respective electrical socket of the building, the respective electrical sockets being coupled to the electrical network of the building; and
one or more subscribers unit disposed inside the building, each subscriber unit having a first interface that is coupled to the electrical network,
wherein each subscriber unit is in communications with the communications network via the electrical network.

22. The system according to claim 21, wherein the system is used for apartment-based high speed communications over the electrical network of a multi-level building.

23. The system according to claim 21, wherein the first interface of each host unit is coupled to the communications network via a connection device.

24. A method for providing communications network access over an electrical network of a building, comprising the steps of:
(a) plugging a host unit to a first electrical socket of the building;
(b) coupling the first electrical socket of the building to the electrical network of the building;
(c) coupling a subscriber unit to the electrical network of the building;
(d) coupling the host unit to a communications network; and
(e) passing information between the communications network and the first subscriber unit via the electrical network of the building.

25. The method according to claim 24, wherein the step (e) includes the step of passing information, via the host unit, between the communications network and the first subscriber unit via the electrical network of the building.

26. The method according to claim 24, wherein the step (c) includes the step of plugging the subscriber unit into a second electrical socket that is coupled to the electrical network.

27. The method according to claim 24, further comprising the steps of:
(f) coupling another subscriber unit to the electrical network of the building; and
(g) passing information under control of the host unit between the subscriber unit of step (f) and the subscriber unit of step (c) via the electrical network.
